(19) United States
(12) Patent Application Publication
(10) Pub. No.: US 2022/0369267 A1
(43) Pub. Date: Nov. 17, 2022

(54) UNIVERSAL REMOTE DEVICE ACTIVATION SYSTEM

(71) Applicants: Michael Cardillo, Point Pleasant, NJ (US); Eric Weaver, West Chester, PA (US); Oleg Boyarsky, Cherry Hill, NJ (US)

(72) Inventors: Michael Cardillo, Point Pleasant, NJ (US); Eric Weaver, West Chester, PA (US); Oleg Boyarsky, Cherry Hill, NJ (US)

(21) Appl. No.: 17/664,157

(22) Filed: May 19, 2022

Related U.S. Application Data
(60) Provisional application No. 63/200,854, filed on Mar. 31, 2021.

(51) Int. Cl. H04W 60/04

(52) U.S. Cl. CPC H04W 60/04; G16Y 30/00

(57) ABSTRACT

A process of administering electronic device registration and authentication includes receiving an access request; comparing the credentials to credential data within a database; scanning for available communications channels; reporting available communications channels to an activation administrator server via one of the channels; and initiating activation of an activatable electronic device. The access request includes credentials and attribute data. The device can self-administer the process by an available means of communication. The device includes a memory, communications interfaces, and a processor. The processor identifies a unique attribute of the device and obtains and populates a form to generate an activation request including the device attribute, information associated with the device, and an intended usage. The activation request is forwarded to the server using the interface. The processor receives activation information and stores the information to the memory; activates the device; and generates a reporting message.

### CROSS-REFERENCE TO RELATED APPLICATION

This application claims the benefit of priority of U.S. provisional application No. 63/200,854, filed Mar. 31, 2021, the contents of which are herein incorporated by reference.

### BACKGROUND OF THE INVENTION

The present invention relates to device activation and, more particularly, to universal remote device activation.

A wide variety of devices, a subset of devices collectively dubbed “the internet of things”, require registration using a mobile app to use them. To activate existing devices, the devices either require direct interaction via a visual user interface, or they require a highly technical person (hereinafter referred to as a “registrant”) to be at or near a device to be activated, even though in many cases they are not the actual user of the device. The registrant's mobile phone may act as a sensor of available communications networks. Further, existing devices rely on heavy user interaction by visual and/or mechanical methods (e.g., with buttons). These features are highly limiting, especially for elder and/or non-technical populations, and may be impractical, particularly as the means of device communication may change (e.g., to a different Wi-Fi® [a family of wireless network protocols, based on the Institute of Electrical and Electronics Engineers (IEEE) 802.11 family of standards; radio signal sent from a wireless router to a nearby device]) or the device may be moved. Re-registering the device may be difficult. Currently, the only way to activate the device to any back-end processing platform is to be in the physical vicinity of the device.

As can be seen, there is a need for a simple way to activate and/or (re)register a device without requiring the registrant's physical proximity to the device.

### SUMMARY OF THE INVENTION

In one aspect of the present invention, a process of administering electronic device registration and authentication comprises providing an activatable electronic device; providing an activation administrator server; receiving at the activation administrator server an access request including credentials and attribute data from an authentication agent; comparing the credentials to credential data within a database; scanning via the activatable electronic device for available communications channels; reporting available communications channels to said activation administrator server via one of the available communications channels; and initiating activation of the activatable electronic device by the one of the available communications channels.

In another aspect of the present invention, an activatable electronic device operative to self-administer registration and authentication functionality by an available means of communication comprises a memory to store one or more instructions; a first communications interface to communicate via a local area network; a second communications interface to communicate via a service network that differs from the local network; and a processor configured to execute the one or more instructions to identify a unique attribute of the activatable electronic device; forward, to a cloud storage, the unique attribute, wherein the cloud storage stores data identifying the activatable electronic device, and wherein the cloud storage identifies an activation administrator server; obtain a form associated with the activation administrator server; populate the form to generate an activation request based on the unique attribute of the activatable electronic device, wherein the activation request relates to activating the activatable electronic device, and wherein the activation request includes the unique attribute of the activatable electronic device, information associated with the activatable electronic device, and an intended usage for the activatable electronic device; forward the activation request to the activation administrator server using the first communications interface or the second communications interface; receive, from the activation administrator server and using the first communications interface or the second communications interface, activation information for activating the activatable electronic device; store the activation information to the memory; activate the activatable electronic device with the activation information; and generate a reporting message based on the unique attribute identified by the processor.

The present invention provides a method, system, and device for a controlled activation on behalf of anyone anywhere in the world, regardless of communication channels available at the time of registration. The purpose of the invention is to allow remote device activation and initialization for devices including, but not limited to, voice interactive devices such as smart speakers. Remote registering allows a single registrant to setup devices for one or many device-users regardless of physical proximity to the device, providing tremendous flexibility to the user. The present invention allows the device to be wherever the end user of the device is and not necessarily where the registrant of the device is. This facilitates the re-registration process when the means of communications change and/or when the device is moved. These devices may be used in a range of industrial applications including, but not limited to, medical, automotive, entertainment, and manufacturing sectors.

These and other features, aspects and advantages of the present invention will become better understood with reference to the following drawings, description, and claims.

### BRIEF DESCRIPTION OF THE DRAWINGS

FIG. 1 is a block diagram of a universal remote activation method according to an embodiment of the present invention;

FIG. 2 is a schematic diagram of a universal remote activation system therefor, according to an embodiment of the present invention;

FIG. 3 is a combination block diagram and flowchart of a back-end server and its operation according to an embodiment of the present invention;

FIG. 4 is a block diagram of architecture of a device according to an embodiment of the present invention; and

FIG. 5 is a block diagram of a communications layer thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, registration refers to identifying a device with a device certificate or authorization token and a device serial number and locating the device in a device registration database or adding the device to a device registration database. As used herein, an “always connected” or “always on” device refers to a device that continuously searches for available communications channels and utilizes at least one of the available communications channels to communicate with a back-end platform or activation administrator server. As used herein, the “state” of a device may include, but is not limited to, its power status (i.e., on or off), its charging state, the communications environment available to the device, the current usage mode (i.e., listening, mute, working, paused, active, etc.), and the device's current memory status.

Broadly, one embodiment of the present invention is a method of remote device activation and a registration system therefor. The system includes an always connected device which, upon power-up, continuously collects the status of available communications channels and communicates the communication channel options to a back-end platform. The present invention resolves the problem of not being physically close to a device by way of several integrated factors.

In some embodiments, the device may have an always-connected capability to a back-end platform, so that the device may still communicate with the back-end platform and perform the registration process even, for example, with no Wi-Fi® availability. Generally, a device according to the invention may be always connected, whether by way of a plugged-in network connection or by way of a radio frequency (RF) -based communication channel. If one communication channel fails, the device may identify an alternative communication channel and may re-establish communication with the back-end platform.

In some embodiments, the inventive method may comprise use of multiple communications channels during the registration process as they become available. For example, multiple-channel, incremental registration, may be performed starting out with 4G and finalizing via Wi-Fi® if 4G is no longer available.

It is generally assumed that the device is operating properly and is able to perform its basic registration functionality. In some edge cases, where this is not possible, for instance, where there is no adequate power to operate the device, a registration process according to an embodiment of the present invention may inherently have additional steps.

Further, in some embodiments, the invention includes a unique device identifier entry logic means, along with a mobile application and software scheme, to identify and register the device for a user regardless of the physical location of the device or of the user. Once identified, the device may serve as a remote sensor or beacon to determine types of connectivity the device has available to it and to provide the remote user (i.e., the registrant) the ability to define the preferred method of connectivity. With one or more of these methods, a user may now register and activate any device at any time, regardless of device and/or user location. In some embodiments, the state of the device may prompt data storage, delivery of stored data, or other actions.

The back-end platform may be cloud-based (i.e., a remote platform using internet-based architecture), may be a complementary (i.e., not cloud-based) platform, or may even be an embedded stand-alone service localized on the device. The inventive method may comprise multiple asynchronous process steps to provide incremental data for registration as the communications means become available, thereby providing unrestricted process flow. The registration process may be triggered by the user, the device, and/or the back-end automation system. Regardless of how the registration process begins, the steps accumulate until enough information is available to enable the registrant to finalize the device registration regardless of where he or she is physically located relative to the device. Once powered up, a device according to the invention with always-connected capability may sweep the local environment for available communications channels and may utilize whatever means of communication it has available to it to act as its own beacon, thereby periodically transmitting data regarding its local communications environment back to the back-end platform for further processing, enabling the device to take advantage of its environment. Regardless of the communications channel, the back-end processor knows the state of the device, its communications options, and other settings.

A process of remote registration may begin upon registration of a commercial order or upon initiation of any other business trigger. Once the universal registration process is started, an entry may be written into an Activation Table providing currently known information about the device and the user. Once the device reaches an operational state, it may self-report the state of available communications networks using any available means (e.g., Bluetooth®, 4G, Short Message Service (SMS), Wi-Fi®).

One may first establish the device's capability to gather the local communications settings. The local communications settings may be transmitted to the back-end platform in a variety of ways, including but not limited to wired internet connection, Bluetooth®, Wi-Fi®, 4G network, SMS, and 5G network. Other communication means may be present and/or may be added. One may, for example, establish an interface to communicate with the back-end platform and simultaneously select and provide valid communications channel credentials to a preferred communications method. The communications means may have varying degrees of security, ranging from relying on physical proximity, as in the case of Bluetooth®, to use of an activation code. The activation code may be generated at the back-end platform and provided by audio prompt and/or provided by visual interface (i.e., via a camera). Biometrics, tactile communications, and combinations of activation means may be used. Once the preferred communications channel is established, the device may then be deemed registered using the device's preset credentials, and under the control of the back-end platform. The back-end platform acts as the overseer, providing interfaces and data throughout the activation process.

A mobile user or a device may initiate the registration process at any point. If Bluetooth® registration is available, for example, validation of the communications method may be done locally by the mobile user. Stored communications supplied by the device may be provided to the mobile user for validation and registration via password or any other validation means. The mobile unit may associate the device to a particular grouping, such as a group of devices associated with a particular household. Other groups may be suitable based on the application.

The invention may be applied widely as user setup or configuration to a particular environment may be desirable for virtually any device and/or service. It may, for example, be utilized to activate and register an otherwise “blank” device and attach the device to the user's profile or scope of use. This process may be performed in close vicinity to the device, thereby utilizing local communications means, or it may be done remotely, such as a distance of at least 300 feet, even many miles away. At the end of the process, the device may be fully recognized, registered, and defined with the user's preferred settings. The always-connected concept provides significant flexibility, making the invention useful in virtually any environment where a “generic” device/service may be personalized for the user and/or the device or service application. Setup and/or configuration of a device may be accomplished by direct interface with the device/service, by remote access, or even with access via a combination of communications channels. The invention may utilize any available means of communication, providing versatility and universality.

As a fallback in case other means of communications do not work, a statistically calculated activation code may be requested by the device or may be automatically generated at the back-end platform to enable continuation of the registration process. An activation code may be either directly supplied to the user, for example by the manufacturer, to the back-end platform, or to a registrant, or may be supplied to the device to be heard by the user. The activation code may be provided to the user by a means which may include but is not limited to: text message; visual interface/on-screen display such as a mobile device; spoken word such as an audio prompt; automatic generation after a predetermined time; visual interpretation, such as light emitting diodes (LEDs) or even quick response (QR) codes; and any combination thereof. For example, the activation code may be spoken out loud on a mobile device to be heard by the local device user and/or a remote registrant and used to validate activation. The method of activation code delivery may largely be governed by various use-cases and by a predetermined degree of security and flexibility in the final product. The activation code may be validated to prevent any unauthorized tampering. This code provides a measure of security adequate to provide the user a high degree of confidence in the registration process. The activation code security may, in some cases, be replaced with biometric means, such as face recognition or fingerprint, or other means of identification. The activation code may be a security access code that is dynamically generated and may be provided on demand. No existing or future infrastructure is required to implement the invention, as the activation code is directly used with no required in-between gateways

Once the currently device-visible communications parameters are provided, the mobile user(s) may finish the communications validation by supplying credentials to activate one or more channels of communication. Credentials, which may include an authorization command, may be supplied for access to the communications means, to verify a relationship to the device, or both. If and/or when the remote user validates the communications settings with proper credentials, the device may be considered activated and may continue its startup sequence, which may involve downloading various user- and application-driven parameters and settings.

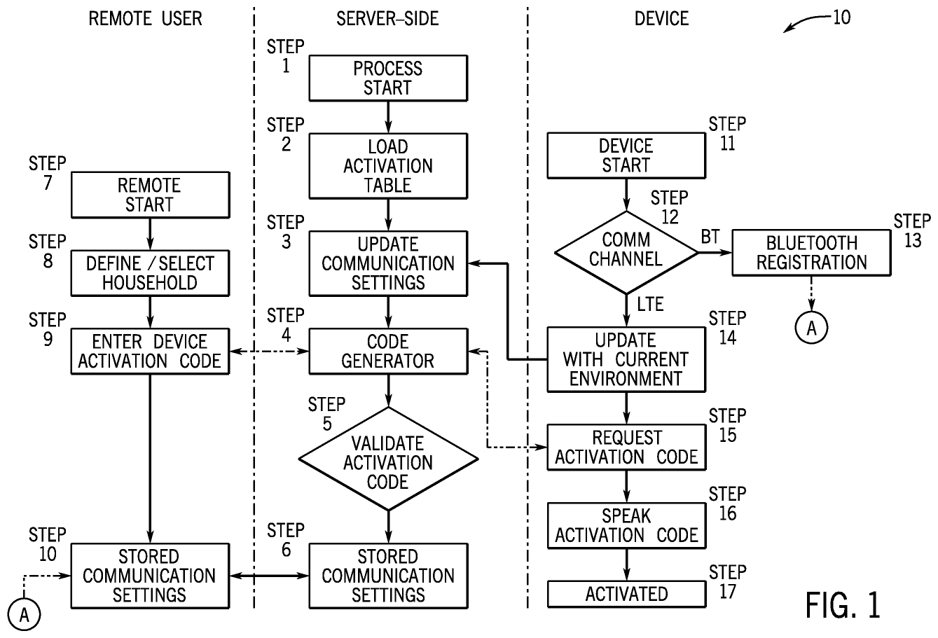

Referring to FIGS. 1 through 5, FIG. 1 provides a flow chart of a method 10 of activating a device according to an embodiment of the present invention. The activation process may start at the device 11, at the back-end server 1, or remotely 7.

For cases wherein activation begins at the device 11, either automatically or initiated by a registrant and/or user, the device may search for available communications channels 12, such as Wi-Fi® by way of Bluetooth® or cellular service at any available speed, such as 3G, Long-Term Evolution (LTE), 4G, or 5G. The device may select Bluetooth® registration 13 and may provide communication settings 10 to the back-end server 30, where the communications settings may be stored 6. Alternatively, the device may select activation by way of cellular service and may update the back-end server 30 with current communications environmental settings 14, 3. The device may request an activation code 15 from the back-end code generator 4, if required. The activation code may be provided visually (not shown) or may be spoken 16. Once the activation code has been entered and validated 5, the device may be considered activated 17. The validation 5 of the activation code may be stored in the back-end platform 6.

For cases wherein activation begins at the back-end server 1, the server may load an activation table 2 and request updated communication settings 3 from the device. In some cases, the back-end server 30 may generate a code 4 for entry into the device. Once the activation code has been entered and validated 5, the device may be considered activated 17. The validation 5 of the activation code may be stored in the back-end database 6.

For cases wherein activation begins remotely 7, the remote registrant may define or select a household or device to activate 8. The registrant may obtain and remotely enter 9 an activation code from the code generator 4. Upon entry and validation of the activation code, the device may transmit available communication settings 10 to the back-end server 30. The validation of the activation code and the available communication settings may be stored in a back-end database 6. The device may then be considered activated 17.

If remote registration 7 is selected, the device may act as its own beacon to determine the current state of its environment and may communicate this state to the server 14, 3. The system may generate activation codes either at the REMOTE side 4 or at the DEVICE side 15 and provide the activation code(s) to the registrant by means of, for example, speech or visual display. The entire activation process may be completely self-contained and universal regardless of the current communications status. The ability for the device to be “always-on” by utilizing multiple means of communications provides flexibility and universality.

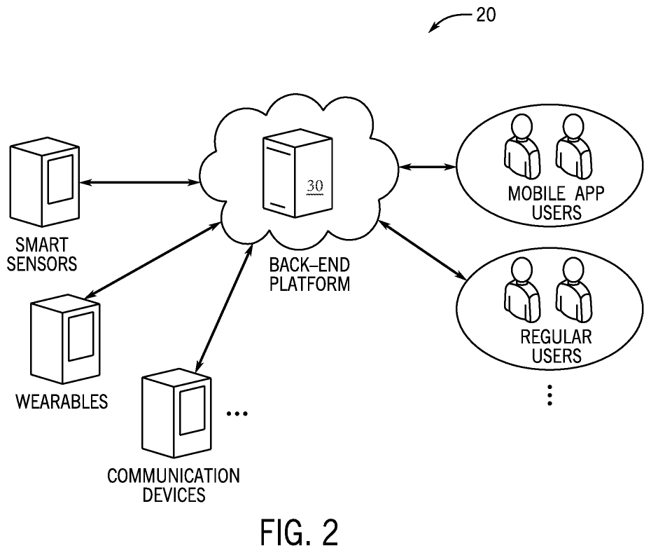

FIG. 2 is a schematic diagram illustrating a system 20 according to an embodiment of the present invention comprising devices requiring activation, such as smart sensors, wearables, and communication devices; a back-end server 30; and device users and remote registrants who may utilize the inventive system 20 to register and activate the devices for the device users.

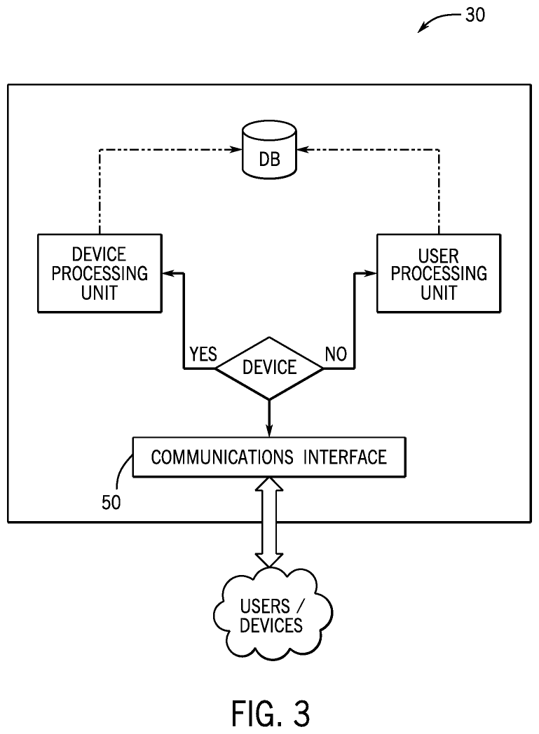

The back-end platform 30 of the present invention generally receives numerous communication requests via its Communications Interface 50, as shown in FIG. 3. These communication requests may come in a variety of formats, including network access such as application programming interface (API)-type calls, direct keyboard entries, biometric requests, and more. Local area networks and wide area networks may be used. The communications interface or layer 50 generally determines the origin of the request (Device or User) and routes the request to an appropriate processing unit. The Device Processing Unit accepts the requests as an instantaneous “environment” update, in that the information provided defines the device-local available communications capabilities. This information may be stored in the database (DB) unit. Numerous devices may asynchronously update this information. If the incoming communication deals with user information, the User Processing Unit, using the DB unit, determines and matches the activation request to the appropriate device.

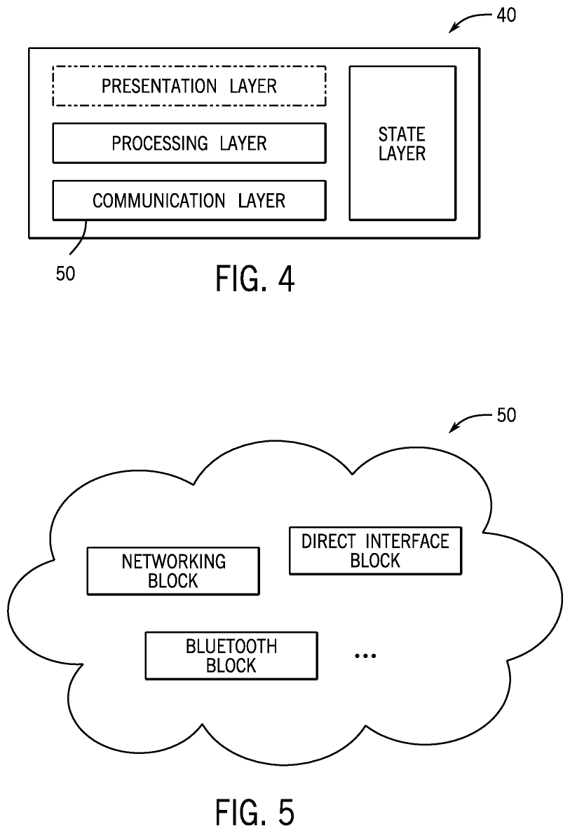

The device architecture 40 comprises four main components illustrated in FIG. 4. The Communications Layer 50 is mainly responsible for both the input and output interactions with the outside world. This is a critical component as it defines the modes of operation available and/or required to activate the device. This layer may be “generic” but is preferably highly customized to the type and use of the device. That is, a smart speaker may contain a much different communications layer 50 than an alarm clock, for example. The device need not have a same or even similar software architecture or base and may be produced by a multitude of manufacturers. The Processing Layer is responsible for all the device logic and processing to provide the device's functionality. In some embodiments, a Presentation Layer may be responsible for providing a device-specific interface to the user. Unlike the Communication layer 50 which provides a transactional capability with the outside world, the presentation layer is dedicated to user-centric response. For example, in a case of a smart speaker, the presentation layer may be responsible for the audio output to the user. In a case of an alarm clock, the presentation layer may consist of only a visible LED(s) to indicate operational status, for example. The presentation layer may be highly customized depending on the device, its activation method, and its use-case. The State Layer provides an instantaneous snapshot of the current device environment, including its activation setting. In case of communication channels shifting, the State layer may hold the currently available communications channels available to use. Once activated, this layer may also hold this status to enable the device's intended use. Device re-activation may be accomplished by clearing the State Layer.

The Communications Layer 50 is a loosely coupled collection of functional blocks shown in FIG. 5 that are highly dependent on the device and its use-case. At a minimum, the communications layer 50 includes a Networking Block for basic Transmission Control Protocol/Internet Protocol (TCP/IP) stack functioning as well as Ethernet and/or Wi-Fi® channels. The device preferably provides a Bluetooth® interface capability as well. In some embodiments, the device preferably provides a Direct Interface block for direct interface (e.g., keyboard, button, touch, etc.). This may, of course, be extended to include a combination of non-human devices, such as sensors, including temperature, pressure, humidity, biometric and more. Other interface blocks may be added for various device categories.

It should be understood, of course, that the foregoing relates to exemplary embodiments of the invention and that modifications may be made without departing from the spirit and scope of the invention as set forth in the following claims.

What is claimed is:

1. A process of administering electronic device registration and authentication, comprising:
a) providing an activatable electronic device;
b) providing an activation administrator server;
c) receiving at the activation administrator server an access request including credentials and attribute data from an authentication agent;
d) comparing the credentials to credential data within a database;
e) scanning via the activatable electronic device for available communications channels;
f) reporting available communications channels to said activation administrator server via one of the available communications channels; and
g) initiating activation of the activatable electronic device by the one of the available communications channels.

2. The process of claim 1, wherein the steps of scanning, reporting, and initiating activation are performed incrementally by way of more than one of the available communications channels.

3. The process of claim 1, wherein the available communications channels are selected from the group consisting of audio, tactile, radio frequency, wide area network, local area network, wireless network protocol, SMS, biometrics, visual interface, and combinations thereof.

4. The process of claim 1, wherein the step of initiating activation comprises transmitting to the activatable electronic device via the one of the available communications channels an authorization command; identifying an attribute of the activatable electronic device; and forwarding the attribute to the database.

5. The process of claim 1, wherein the step of receiving further comprises transmitting a form from the activation administrator server to the authentication agent; populating the form by the authentication agent to generate the access request, wherein the access request relates to activating the activatable electronic device; and forwarding the form from the authentication agent to the activation administrator server.

6. The process of claim 1, wherein the authentication agent is at least 300 feet from the activatable electronic device.

7. An activatable electronic device operative to self-administer registration and authentication functionality by an available means of communication, comprising:
a) a memory to store one or more instructions;
b) a first communications interface to communicate via a local network;
c) a second communications interface to communicate via a service network that differs from the local network; and
d) a processor configured to execute the one or more instructions to:
i. identify a unique attribute of the activatable electronic device;
ii. forward, to a cloud storage, the unique attribute, wherein the cloud storage stores data identifying the activatable electronic device, and wherein the cloud storage identifies an activation administrator server;
iii. obtain a form associated with the activation administrator server;
iv. populate the form to generate an activation request based on the unique attribute of the activatable electronic device, wherein the activation request relates to activating the activatable electronic device, and wherein the activation request includes the unique attribute of the activatable electronic device, information associated with the activatable electronic device, and an intended usage for the activatable electronic device;
v. forward the activation request to the activation administrator server using the first communications interface or the second communications interface;
vi. receive, from the activation administrator server and using the first communications interface or the second communications interface, activation information for activating the activatable electronic device;
vii. store the activation information to the memory;
viii. activate the activatable electronic device with the activation information; and
ix. generate a reporting message based on the unique attribute identified by the processor.

8. The activatable electronic device of claim 7, comprising a logic means of identifier entry selected from the group consisting of: physical; audio; proximity to a sensor; biometric; automatic after a predetermined time; and a combination thereof.

9. The activatable electronic device of claim 7, wherein the activatable electronic device is operative to periodically transmit to an activation administrator server information selected from the group consisting of alternative communication methods, environmental settings, and combinations thereof.
